(19) United States
(12) Patent Application Publication
(10) Pub. No.: US 2009/0175742 A1
(43) Pub. Date: Jul. 9, 2009

(54) Hydraulic supply system for a motor vehicle

(75) Inventors: Marco Grethel, Buhlertal (DE); Jochen Pfister, Strasbourg (FR); Ronald Glas, Obersasbach (DE); Eric Muller, Kaiserslautern (DE); Roshan Willeke, Karlsruhe (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/316,671

(22) Filed: Dec. 15, 2008

Related U.S. Application Data
(60) Provisional application No. 61/007,468, filed on Dec. 13, 2007.

(51) Int. Cl. F04B 35/00; F04B 35/04; B60K 17/10

(52) U.S. Cl. 417/364; 417/410.1; 477/3

(57) ABSTRACT

A hydraulic supply system for a motor vehicle includes an internal combustion engine, a pump driven by the internal combustion engine, and a hydraulically operated component that is driven by hydraulic fluid transported by the pump. An electric motor is provided to drive the pump when the internal combustion engine is not running.

### BACKGROUND OF THE INVENTION

1. Field of the Invention

The invention relates to a hydraulic supply system for a motor vehicle, having an internal combustion engine, a pump driven by the combustion engine, and a consumer that is drivable by means of hydraulic fluid transported by the pump.

2. Description of the Related Art

Automatic vehicle transmissions frequently have controlling and shifting elements operated by means of hydraulic pressure. Hydraulic pressure is normally supplied by a pump that is driven by an internal combustion engine, which is also the propulsion engine of the motor vehicle. Drive systems are known in which the internal combustion engine is shut off automatically in operating phases in which it is not needed to propel the motor vehicle, such as when the vehicle is stopped at a traffic light or is in a traffic jam. So that the vehicle is always ready to drive immediately in such operating phases, i.e., when the internal combustion engine is not running, the supply of hydraulic fluid to the hydraulic actuators of the transmission must be maintained. That is usually accomplished by providing an auxiliary pump that is driven by its own electric motor, and that goes into action as soon as the internal combustion engine—and thus also the pump driven by the internal combustion engine—is inoperative.

An object of the present invention is to provide an inexpensive and simply constructed hydraulic supply system, in which the hydraulic supply system for a hydraulically operated component that is normally supplied with hydraulic fluid by means of a pump driven by an internal combustion engine remains operationally ready or in operation even when the internal combustion engine is not running.

### SUMMARY OF THE INVENTION

The object is achieved with a hydraulic supply system in accordance with the present invention in which a separate pump is not used, but rather the pump normally driven by the internal combustion engine is driven by an electric motor when the internal combustion engine is not running.

A hydraulic supply system in accordance with the present invention for a motor vehicle includes an internal combustion engine, a pump driven by the internal combustion engine, and a hydraulically operated component that is driven by means of hydraulic fluid transported by the pump, and it also includes an electric motor to drive the pump when the internal combustion engine is not running.

Advantageously, the internal combustion engine and the electric motor drive the pump through a transmission including a free wheeling mechanism, and in such a way that the driving of the pump is always effected by whichever of the engine or the electric motor can drive the pump at a higher rotational speed.

The pump can be a multiple-flow pump, whose flow paths are selectively switchable.

The hydraulic supply system in accordance with the present invention can be utilized for operating a variety of hydraulically operated components, such as hydraulic steering systems, air conditioners, brake boosters, clutches, etc. It is especially well suited for hydraulically operated components at least one of which is a hydraulically operated automatic vehicle transmission.

One of the flow paths can be connected to the automatic vehicle transmission and another flow path can be connected to at least one other hydraulically operated component.

The speed of the electric motor can be variable, as a function of particular operating parameters of a power train of the vehicle.

### BRIEF DESCRIPTION OF THE DRAWINGS

The structure, operation, and advantages of the present invention will become further apparent upon consideration of the following description, taken in conjunction with the accompanying drawings in which:

FIG. 1 is a block diagram of a first embodiment of a hydraulic supply system in accordance with the present invention for a motor vehicle, and

FIG. 2 is a block diagram of another embodiment of a hydraulic supply system in accordance with the present invention that is a modification of the system shown in FIG. 1.

### DESCRIPTION OF THE PREFERRED EMBODIMENTS

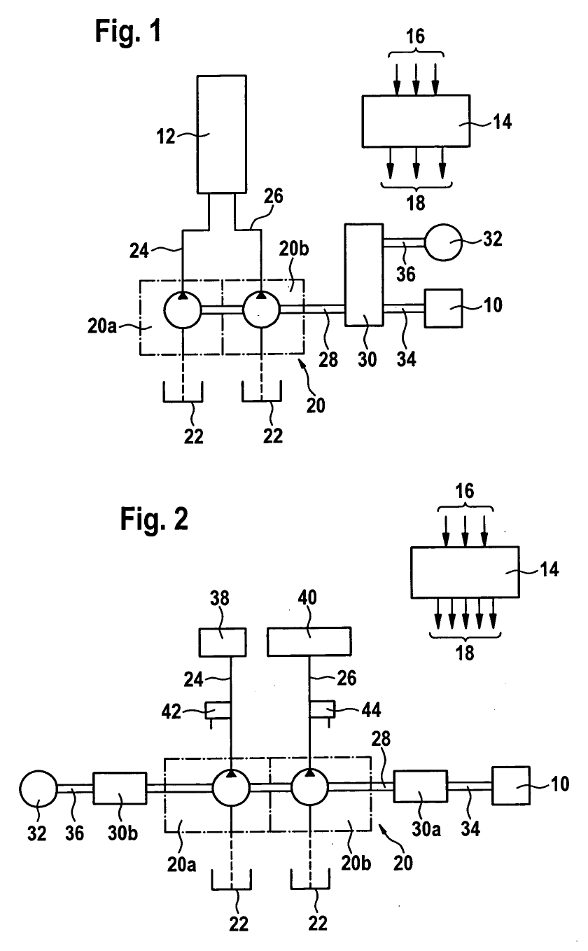

Referring to FIG. 1, a motor vehicle (not shown), a passenger car for example, includes an internal combustion engine 10, which drives vehicle wheels (not shown) in a known manner by way of an automatic transmission, for example a transmission having a continuously variable transmission ratio. Such automatic transmissions are known, and therefore will not be further described. Also known are actuation units 12 working with hydraulic pressure for such transmissions, which are controlled by an electronic control device 14 as a function of operating parameters of the vehicle, for example the vehicle velocity, the operation of a gas pedal, etc. Such actuation units 12 include valves that are actuated by the electronic control device and by means of which the actuation of operators or control devices that set the particular transmission ratio of the transmission is controlled. When individual gears are shifted automatically in the automatic transmission, normally a selecting actuator, a shifting actuator, and a clutch are hydraulically operated and electronically controlled.

Inputs 16 to the electronic control device 14 are connected to sensors that register operating parameters of the vehicle power train, such as the speed of the vehicle, the position of a gas pedal, the position of a brake pedal, etc. Outputs 18 are connected to valves or other actuation units 12 and possibly a power control element of combustion engine 10.

Hydraulic fluid is supplied to actuation units 12 by a pump 20, which in the illustrated example is in the form of a two-flow or a double-flow pump, with a first pump section 20a that provides a first flow and a second pump section 20b that provides a second flow 20b. Pump 20 draws hydraulic fluid from a reservoir 22 and transports it into a first output line 24 that is connected with the first pump section 20a and into a second output line 26 that is connected with the second pump section 20b. The two pump sections or flows can be designed in such a way that a different pressure level exists in the respective output lines 24, 26, which is matched to the requirements of the actuation units 12.

Multiple-flow pump 20 can be of known construction, and can have a single impeller that delivers hydraulic fluid into different transport lines at different pressure levels, or separate impellers situated on a common pump shaft 28, so that the two flows from the pump sections 20a and 20b are provided by independent pumps that are driven by a common pump shaft 28.

Pump shaft 28 is driven by internal combustion engine 10, in that case through a transmission 30 to adjust the speed of rotation.

The arrangement described previously and its sub-assemblies are known, and therefore will not be explained in further detail.

According In accordance with the present invention, in addition to the internal combustion engine 10 an electric motor 32 is provided, and transmission 30 is designed so that pump shaft 28 is drivable through transmission 30 by means of electric motor 32 when internal combustion engine 10 is not running. For that purpose, transmission 30, which can be of known construction, includes at least one free-wheel mechanism that enables an output shaft 34 of internal combustion engine 10 to be stationary, while the pump shaft 28 is driven by an output shaft 36 of electric motor 32 through transmission 30. Advantageously, there is a free-wheel mechanism in each of the connections of output shaft 34 or of output shaft 36 to a respective transmission element, which free-wheel mechanism is non-rotatably connected to pump shaft 28, ensuring that the respective transmission element is able to overtake the corresponding output shaft, so that pump shaft 28 is always driven by that output shaft 34 or 36 that provides a higher speed of rotation to pump shaft 28.

The operation of electric motor 32 is controlled by electronic control device 14, which drives electric motor 32 at a predetermined speed or a speed that is a function of operating parameters, as soon as pump 20 is no longer driven by internal combustion engine 10.

Electric motor 32 can also be used advantageously to drive pump 20 when internal combustion engine 10 is rotating at a lower speed. That enables design freedoms in the design of the pump. For example, the pump can be designed in such a way that a narrower spread of speeds is provided within which the actuation unit 12 is supplied with adequate hydraulic pressure.

FIG. 2 shows another embodiment of the hydraulic system in accordance with the present invention, one that is a modification of the hydraulic system shown in FIG. 1.

Pump shaft 28 extends through the entire pump 20, and is connected at one end through a first transmission 30a to the output shaft 34 of internal combustion engine 10, and at the other end through a second transmission 30b to the output shaft 36 of electric motor 32. Instead of the actuation unit 12 of FIG. 1, which has two inputs for connection with output lines 24 and 26, respectively, two hydraulically operated components 38 and 40 are provided, which are connected to output lines 24 and 26, respectively. The two hydraulically operated components 38 and 40 can be parts of actuation unit 12, or they can be separate hydraulically operated components. For example, hydraulically operated component 38 can be the actuation unit for a transmission, and hydraulically operated component 40 can be the actuation unit for a clutch. In each of the output lines 24 and 26 a pressure limiting valve 42, 44, respectively, is provided, with a return line leading into hydraulic fluid reservoir 22, by means of which the pressure in the particular output line 24 or 26 can be adjusted. Electronic control device 14 has outputs 18, one of which is connected to electric motor 32, others of which are each connected to one of the pressure limiting valves 42 and 44, and still others of which can be connected to other electronically controlled components.

The functioning of the arrangement shown in FIG. 2 corresponds with that shown in FIG. 1. A free-wheel mechanism is included in each of the transmissions 30a and 30b that permits pump shaft 28 to overtake the respective output shaft 34 or 36, or allows pump shaft 28 to be driven by that one of the output shafts 34 and 36 that will result in a higher rotational speed for pump shaft 28. Pressure limiting valves 42 and 44 enable a pressure that is a function of operating parameters of the vehicle power train to be set selectively in the respective output lines from pump sections 20a and 20b, which pressure can be lowered, for example if pump 20 is driven by means of electric motor 32. In that way, it is possible to design a weaker electric motor 32. Of course, a pump flow can be set to circulate or it can be completely deactivated.

The invention described above by way of example can be modified in many ways. For example, pump 20 can be designed as a single-flow pump, or with more than two flows, which are matched to different hydraulically operated components. The transmissions 30, or 30a and 30b, with the aid of the free-wheel mechanisms, not only permit the pumps to be driven optionally by internal combustion engine 10 and/or by electric motor 32, but also enable the speed of rotation to be adjusted between pump 20 and the particular engine or motor. The system in accordance with the present invention can also be employed in a hybrid drive system, in which the vehicle is driven optionally by an internal combustion engine and/or by an electric motor.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic supply system for a motor vehicle, said hydraulic supply system comprising: an internal combustion engine, a hydraulic pump driven by the internal combustion engine, a hydraulically operated component that is operated by hydraulic fluid supplied by the pump, and an electric motor operatively connected with the pump for driving the pump when the internal combustion engine is not running.

2. A hydraulic supply system in accordance with claim 1, wherein the internal combustion engine and the electric motor are each operatively connected to the pump through a transmission that includes a free-wheel mechanism, wherein operation of the pump is always effected by whichever of the engine or motor can drive the pump at a higher rotational speed.

3. A hydraulic supply system in accordance with claim 1, wherein the pump is a multiple-flow pump having separate output flow paths that are selectively engageable.

4. A hydraulic supply system in accordance with claim 1, wherein the hydraulically operated component is an actuating mechanism of an automatic vehicle transmission.

5. A hydraulic supply system in accordance with claim 3, wherein one of the output flow paths is connected to an automatic vehicle transmission and another output flow path is connected to at least one other hydraulically operated component.

6. A hydraulic supply system in accordance with claim 1, wherein the rotational speed of the electric motor is adjustable as a function of operating parameters of a power train of the motor vehicle.
